(19) United States
(12) Patent Application Publication
(10) Pub. No.: US 2011/0241834 A1
(43) Pub. Date: Oct. 6, 2011

(54) Intrinsic Consumer Warnings and Pinch Peel Plates for RFID Inlays

(76) Inventors: Clarke William McAllister, Eugene, OR (US); Daniel Shihady Campbell, Boston, MA (US)

(21) Appl. No.: 13/031,610

(22) Filed: Feb. 21, 2011

Related U.S. Application Data
(60) Provisional application No. 61/306,939, filed on Feb. 22, 2010.

(51) Int. Cl. H04Q 5/22; G06K 19/077

(52) U.S. Cl. 340/10.1; 235/492

(57) ABSTRACT

The present invention provides for efficient use of radio frequency identification (RFID) inlays by eliminating the need for a printable face stock layer. The present invention provides improved and simplified RFID tagging operations to dispense RFID inlays thus eliminating the need for additional steps to convert RFID inlays into RFID tags or labels. Intrinsic consumer warning markings eliminates the need for a secondary printing process to provide required consumer warning text or symbols on a thin clear inlay. The present invention also provides for improved elements and structures for controlling the separation of thin, clear, shiny inlays from a conveyance web.

### RELATED APPLICATIONS

This document claims priority and benefit for all purposes of U.S. provisional patent application No. 61/306,939 filed on 22 Feb. 2010, disclosure of which is expressly incorporated by reference for all purposes.

### BACKGROUND

The present invention relates to a system, including methods and devices, utilizing wireless sensor devices and RFID (radio-frequency identification) transponders, tags, and inlays. Specifically, the present invention relates to a system incorporating novel devices and methods that enable point-of-use and on-demand commissioning of RFID transponder-equipped wireless sensors.

Radio-frequency identification (RFID) transponders enable improved identification and tracking of objects by encoding data electronically in a compact tag or label. And, advantageously, the compact tag or label does not need external, optically recognizable or human-readable markings. In fact, using the Gen2 EPC specification, a three-meter read-distance for RFID transponders is common—even on high-speed material handling lines.

Radio-frequency identification (RFID) transponders, typically thin transceivers that include an integrated circuit chip having radio frequency circuits, control logic, memory and an antenna structure mounted on a supporting substrate, enable vast amounts of information to be encoded and stored and have unique identification. Commissioning, the process of encoding specific information (for example, data representing an object identifier, the date-code, batch, customer name, origin, destination, quantity, and items) associated with an object (for example, a shipping container), associates a specific object with a unique RFID transponder. The commissioned transponder responds to coded RF signals and, therefore, readily can be interrogated by external devices to reveal the data associated with the transponder.

RFID interrogators or the components to build them are commercially available from many suppliers, including: Impinj, Inc. of Seattle, Wash., SkyeTek, Inc. of Denver, Colo., and ThingMagic, a Division of Trimble. The SkyeTek M9 and ThingMagic M5e-Compact are representative examples of commercially available RFID interrogators.

Current classes of RFID transponders rank into two primary categories: active RFID transponders and passive RFID transponders. Active RFID transponders include an integrated power source capable of self-generating signals, which may be used by other, remote reading devices to interpret the data associated with the transponder. Active transponders include batteries and, historically, are considered considerably more expensive than passive RFID transponders. Passive RFID transponders backscatter incident RF energy to specially designed remote devices such as interrogators.

Combining the benefits of the latest technology in RFID transponders with sensing devices, a broader class of devices called wireless sensors is emerging. Wireless sensors have a unique identity, sense one or more attributes within its environment, and report its identity and data corresponding to the sensed attributes. For example, a wireless sensor interprets environmental conditions such as temperature, moisture, sunlight, seismic activity, biological, chemical or nuclear materials, specific molecules, shock, vibration, location, or other environmental parameters. Wireless sensors are distributed nodes of computing networks that are interconnected by wired and wireless interfaces.

Wireless sensors, made using silicon circuits, polymer circuits, optical modulation indicia, an encoded quartz crystal diode, or Surface Acoustic Wave (SAW) materials to affect radio frequency or other signaling methods, communicate wirelessly to other devices. For example, certain embodiments of wireless sensors communicate on a peer-to-peer basis to an interrogator or a mobile computer. Communication methods include narrow band, wide band, ultra wide band, or other means of radio or signal propagation methods.

With the manufacturing and production of RFID tags, there is a major effort to minimize the cost per tag. By minimizing the costs of tags, it is seen that mass adoption of the technology can occur thus lowering the overall costs of RFID even more given the economies of scale. In the manufacturing and production of RFID tags, a substantial amount of the overall cost involved is attributed to the material costs and the handling of tags during the converting process. As a result, there is much value behind methods that minimize material use and handling. Handling can include both the handling of RFID tags while at the converter, but also the transferring of inlays to a converter company.

RFID label construction typically comprises a silicone-coated release liner, a pressure sensitive layer disposed onto a substrate layer, an RFID antenna and chip disposed onto the substrate layer and a face stock material that covers the RFID antenna, chip, and substrate.

Prior art addresses the need for consumer warning messages on the RFID tags by using human readable print on a visible face stock top surface. The elimination of the face stock as a component of a finished RFID tag poses challenges that are overcome by the present invention.

U.S. Pat. No. 7,398,999 “Visual verification of prescription medication and information and warning label” issued 15 Jul. 2008 teaches a means for providing consumer notification through a pharmaceutical label in order to comply with required consumer warnings for prescription pharmaceutical bottles. Inventor Stacy R. Kaufman teaches a unique label format to allow for printing area that can be used to display the required consumer notifications. The present invention addresses a similar consumer notification requirement for RFID tags by making use of existing RFID antenna fabrication methods to eliminate the costly secondary printing steps that are expressed in the prior art.

In the prior art of RFID antenna production it is known that multiple methods exist for manufacturing said antennas. All of which can be used as a means for printing required consumer notifications. Though no prior art claims methods or systems of manufacturing antennas that can be applied towards the manufacturing of consumer notifications in the form of symbols or human readable information.

In U.S. Pat. No. 7,250,868 “Manufacture of RFID tags and intermediate products therefor”, inventors Kurt and Dunn teach an improvement in the manufacturing of RFID tags which employs an antenna stamped from a thin metallic sheet and affixed to a substrate. The antenna then goes through multiple intermediate processes such that the final product results in an operational RFID tag. This patent is specific to the manufacturing of an RFID antenna, using the low cost methods of stamping. Although printing technologies are well known, this patent fails to anticipate the economic advantages related to the production of consumer notifications in this primary process so as to avert the additional cost of a secondary printing process.

U.S. Pat. No. 6,140,146 “Automated RFID transponder manufacturing on flexible tape substrates” teaches a unique method of manufacturing RFID tags such that the final roll of tags is dispensed in the length direction as to allow for the length of the tags' antenna to be adjusted to satisfy the requirements of multiple applications. This patent is specific to RFID antenna layout, and refers to such antennae as a singular metallic pattern. Although printing technologies are well known, this patent fails to anticipate the economic advantages related to the production of consumer notifications in this primary process so as to avert the additional cost of a secondary printing process.

In U.S. Pat. No. 7,421,775 “Method of manufacturing antenna for RFID tag” inventors Kwak et al teach a method of inexpensively manufacturing an RFID antenna by forming the antenna using magnets of a pattern corresponding to the desired antenna shape. This patent is specific to the manufacturing of an RFID antenna, using the cost effective methods of pattern shaping with magnets. Although printing technologies are well known, this patent fails to anticipate the economic advantages related to the production of consumer notifications in this primary process so as to avert the additional cost of a secondary printing process.

In U.S. Pat. No. 5,574,470 “Radio frequency identification transponder apparatus and method” inventor Franklin B. de Vail teaches an apparatus and method of a producing RFID transponder antenna coils, recognized as two halves positioned on a substrate and coupled to the programming pads. This patent teaches only the antennas coils and their sole use for radio communication. Although printing technologies are well known, this patent fails to anticipate the economic advantages related to the production of consumer notifications in this primary process so as to avert the additional cost of a secondary printing process.

In U.S. Pat. No. 6,027,027 “Luggage tag assembly” inventor Smithgall teaches a low cost RFID tag for attaching to and identifying objects such as a passenger's luggage. The tag includes an integrated circuit with all radio and data functions incorporated onto this integrated circuit, and an antenna for radio communication. The luggage tag is assembled inexpensively by packaging the integrated circuit between paper or plastic substrates on which printed identifying information is also added at the point of check-in at the terminal. This patent claims an antenna forming step which includes fabricating the loop antenna by printing a conductive ink onto the substrate material. Of interest to the current patent is the use of conductive ink for forming the antenna. Although printing technologies are well known, this patent fails to anticipate the economic advantages related to the production of consumer notifications in this primary process so as to avert the additional cost of a secondary printing process.

In order to make use of printing consumer notification messages in the same manufacturing process that is used to fabricate the antenna structure, the inlay needs to be visible to the consumer by not having a face stock material covering the RFID inlay. It is well known that RFID inlays without face stock lack robust physical shape retention properties that we have come to associate with RFID tags. The lack of shape retention properties allows adhesive-backed inlays (often referred to as wet inlays) to adhere to silicone-coated release liner even as the liner is flexed and transported over sharp edges that would normally cause RFID tags to peel from the liner. Lacking this ability to be easily peeled from release liner requires that special measures be taken to cause the thin (i.e. flimsy) RFID inlays to peel off.

In the prior art of tag or label separation and dispensing from a release liner, it is well known by those skilled in the art to move release liner (the web) and the attached labels over the edge of a stationary peel plate. At the peel plate the web makes a discrete bend at the edge to reverse its direction. Because of the stiffness of the tag or label being dispensed, it is unable to wrap around the bend to reverse its direction, thus peeling away from the release liner so that it can be removed fully by manual methods or with automated equipment. Such a process proves problematic for separating thin RFID inlays that will not detach from the release liner but instead proceed around the peel plate without peeling. Prior art has addressed this problem with methods and devices that are different from the present invention.

In U.S. Pat. No. 6,210,524 “Method of improving peel-plate dispensability of label constructions” inventor Karl Josephy of Avery Dennison Corporation teaches a method of improving the peel-plate dispensability of die-cut and matrix-stripped label constructions which do not generally have the required minimum stiffness to be successfully peel-plate dispensed, particularly at room temperature. More particularly, the invention relates to a method which comprises maintaining the temperature of the leading edge of the label below a given temperature as the leading edge of the label construction moves over a peel-plate and the label is separated from the release liner. Maintaining a reduced label temperature temporarily increases the stiffness of the label, and, thus, when the cooled label passes over the peel-plate, the label has the required stiffness to cause it to separate from the release liner. The invention is particularly applicable to thin label constructions (e.g., faceless constructions) which do not have the requisite stiffness at room temperature to be peel-plate dispensable. This patent teaches methods of increasing tag stiffness through temperature control, whereas the current invention does not rely upon such exotic methods.

A common problem of thin labels is also the handling of thin labels after being peeled from the release liner.

In U.S. Pat. No. 5,938,890 “Adhesive components peel and apply apparatus and method” inventors Schlinknmann and Schlinknmann teach a solution to said problem by providing an apparatus and method for removing components from a release coated web roll by holding the component, such as a label, securely in a chuck and then peeling the web from underneath the component. By holding the label in a chuck its position can be predictably controlled. This is achieved by forcing a chuck against a component on a movable peeler plate and holding it in place with vacuum. Tension on the web then pulls the peeler plate away from the component while the web passes over the edge of the peeler plate and peels the web from the adhesive face of the component.

In U.S. Pat. No. 5,186,782 “Method for high speed labeling of deformable substrates” inventor Melvin S. Freedman of Avery Dennison Corporation teaches a method wherein labels are peeled from release liner after being treated differently in their lengthwise and cross directions so as to have a different stiffness in the respective directions and achieve a tradeoff between dispensability and conformability superior to that of prior art labels of heat-set polymeric material. In one particular respect, uni-layer polyethylene is treated differently in machine and cross directions to yield improved heat-set polyethylene labels. This patent teaches the manufacturing of tags and labels with unique material properties to tradeoff between dispensability and conformability, whereas in the present invention, the labels are momentarily being altered in shape, not material properties, to improve dispensability.

In U.S. Pat. No. 4,704,317 “Sheetstock dispensable from a corner nip feeder” addresses the problem of paper sheetstock which is too stiff to be dispensed reliably from a printer's corner nip feeders, so the sheetstock is modified by forming a diagonal path of relatively low stiffness across each of at least two adjacent corners, preferably all four corners. Such a path preferably is made by forming slits, scores or a line of perforations extending at 45 degrees to the edges of the sheetstock. Such a solution modifies the stiffness of the sheetstock, but unlike the present invention, the modification to the material is permanent and lowers stiffness.

In U.S. Pat. No. 6,758,254 “Method and apparatus for removing and applying adhesive components” inventors Moore and Gunnerson teach a method and device for removing adhesive backed components from a carrier tape and applying them onto a substrate which utilizes a retracting blade having a top surface for positioning the adhesive backed components. Extension of the retracting blade and advancement of the carrier occur simultaneously and independently from one another thereby enabling a significant reduction in cycle times. This reduction in time being credited to fewer steps and motions in peeling the component form the carrier. While such a method and apparatus are capable of separating thin labels from the release liner it is more complicated than the present invention which uses a stationary peel plate.

In U.S. Pat. No. 6,818,271 “Adhesive coated thin film label” inventors Fearn and Spear teach a unique adhesive coated thin film label and a method for applying a thin film label to a substrate. The thin film label has minimal thickness and is die cut to define a label shape. The label includes visible indica and adhesive is applied to one side of the label film for bonding to the substrate. The indicia is placed using ink in such a pattern to increase label stiffness whereby increasing label dispensability. Such an apparatus and method differs from the present invention in that it permanently alters the shape of the label, whereas the present invention momentarily alters the shape of labels as the labels are being dispensed.

SO, DESPITE RECENT ADVANCES IN RFID TECHNOLOGY, THE STATE-OF-THE-ART DOES NOT FULLY ADDRESS THE NEEDS OF SIMPLE, FAST, EFFICIENT, ECONOMICAL, SMOOTH, RELIABLE COMMISSIONING OF RFID TRANSPONDERS AND THIN INLAYS. LARGE-SCALE ADOPTION AND DEPLOYMENT OF RFID TRANSPONDERS DEPENDS ON THOUSANDS OF DISTRIBUTED LOCATIONS THAT IMPLEMENT SIMPLE AND EFFICIENT MANUAL TAG AND INLAY COMMISSIONING PROCESSES.

### SUMMARY OF THE INVENTION

Secure and efficient encoding of RFID tags, including printed and chipless RFID transponders for item-level supply chain tagging on a global scale requires minimization of the materials consumed for that purpose. Since retailer tagging mandates were first issued in 2003, the industry has gradually eliminated much of the material that is consumed by radio frequency identification (RFID) tags, including toxic materials such as silver. In the transition from pallet tagging to item-level tagging, the physical size of RFID tags has shrunk dramatically.

RFID tags with SGTIN (Serialized Global Trade Item Numbers) encoding convey detailed information about a product that consumers purchase. Privacy groups have expressed concern over this and as such recommend and lobby for consumer notification labeling norms.

The consumer notification referred to in the present invention complies with recommendations of the European communities for the implementation of privacy in applications supported by radio frequency identification. Specifically line 120 of the document COMMISSION OF THE EUROPEAN COMMUNITIES, COMMISSION RECOMMENDATION, on the implementation of privacy and data protection principles in applications supported by radio-frequency identification, Dec. 5, 2009.

The present invention recognizes that many commercial end users of RFID tags unknowingly and unnecessarily use printed face stock only to meet the mandates of consumer privacy that require consumer notification of RFID use.

### DRAWINGS

FIG. 1 is a material stack diagram of a preferred embodiment of an RFID inlay

FIG. 2 shows a preferred embodiment of an RFID inlay with a consumer notification symbol

FIG. 3 is a figure depicting a preferred embodiment of an RFID encoder with a peel plate for peeling thin RFID inlays

FIG. 4 shows an orthogonal view of a preferred embodiment of an RFID tag or inlay encoder

FIG. 5 shows a side view of a preferred embodiment of an RFID tag or inlay encoder

### DETAILED DESCRIPTION OF THE INVENTION

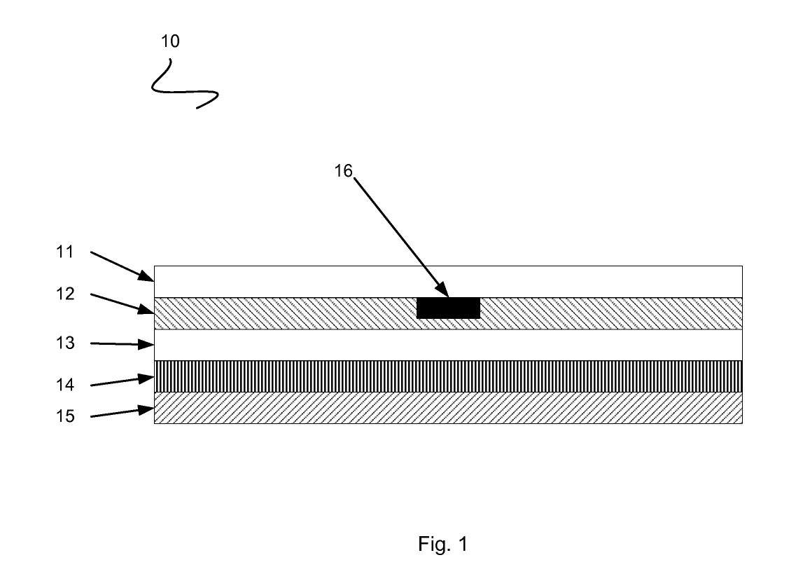

Referring to FIG. 1 there is a preferred material stack diagram for clear wet inlay 10. Face material 11 is preferably comprised of clear PET that is 10 to 50 microns thick. Being clear it provides a view to integrated circuit 16 and antenna 12 that are structurally supported by a preferably clear substrate 13 layer. On the opposite side of substrate 13 is adhesive layer 14, which adheres wet inlay 10 to a conveyance web of low surface energy release liner 15. Typically release liner 15 is a plastic sheet or paper coated with silicone or an organic material with low surface energy. The term ‘wet’ is used for inlays that have adhesive layer 14.

Radio Frequency Identification tags are RFID transponders that include printed and chipless RFID transponders and silicon-based transponders. Wet inlay 10 is a form of an RFID transponder and is preferably based on the EPCglobal specification for Class 1 Generation 2 RFID tags.

In one embodiment, consumer notification can be accomplished by displaying the Electronic Product Code (EPC) Seal 20 on RFID tag or inlay 10. The present invention teaches the elimination of the printed face stock material and the inherent costs that are associated with the production of RFID inlays with paper face stock. In preferred embodiments of the present invention, the consumer notification messages and symbols are imaged onto antenna layer 12 as either a portion of the RFID antenna structure or as nearby text and symbols. Therefore in preferred embodiments, RFID consumer notification text and symbols are intrinsic to the antenna layer of an RFID transponder or clear RFID inlay and are built-in or rendered therein. In printed and chipless RFID the entire transponder circuitry, antenna, and consumer notification text are all intrinsically printed on the same substrate.

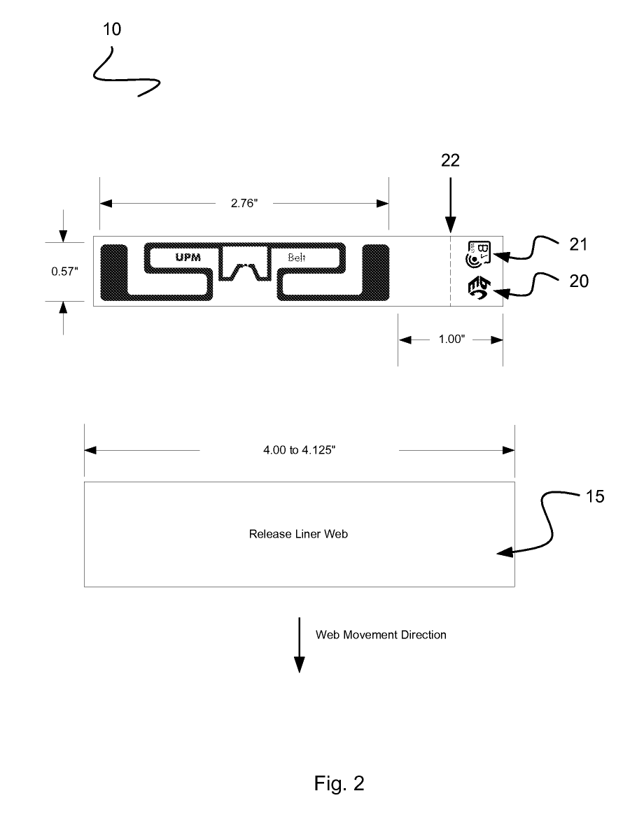

FIG. 2 illustrates a preferred consumer notification symbol, the EPCglobal Seal 20 and ISO Air Interface Symbol 21 in clear wet inlay 10. The consumer notification text and symbols, in the form of symbols or characters is preferably rendered and produced using the same manufacturing processes that are used to manufacture the RFID antenna structure.

The consumer notification symbol is preferably comprised of the same material, same thickness and applied to the same substrate layer as the antenna. As shown in FIG. 2, the EPC Seal 20 and ISO Symbol 21 are not electrically connected to the antenna. In other preferred embodiments it is possible to electrically connect the EPC Seal or any other consumer notification text or symbol such that it works in conjunction with the antenna for RF communications. Applicable manufacturing processes that exist for producing RFID antenna include but are not limited to: electro-chemical etching, deposition, conductive ink printing, stamping, and chipless printing.

The dimensions of inlay shown in FIG. 2 are one embodiment of many possible inlay and web embodiments that can be detected, peeled, and encoded using the present invention. The web width although shown to nominally be 4″, can be wider or narrower. Some inlays from Avery Dennison are available on web widths of about 1.5″ for example. The consumer notification symbols EPC Seal 20 and ISO Symbol 21 may optionally be located in various places on or around the antenna structure of the inlay. Fold 22 is optional as a feature to provide for consumer notification that extends out beyond the hang tag or trim piece that it is attached to. By folding it over at fold 22 with the adhesive portions sticking to each other, the extended portion can be presented to consumers on retail items in a way that is not sticky to the touch.

By using a clear face material 11 such as PET plastic the consumer notification can be viewed through the clear face material and recognized by consumers. The total result is a reduction in material and handling, thus a total reduction in tag cost.

Without a paper face stock layer, such an RFID tag loses much of its stiffness. This adversely affects the dispensability of the RFID tag, wherein the most popular labeling process, the label is separated from the liner by bending the release liner back over a peel-plate, whereupon the label is sufficiently stiff to cause the label to continue on a straight path, overcoming the release force between the inlay adhesive 14 and the silicone-coated release liner 15.

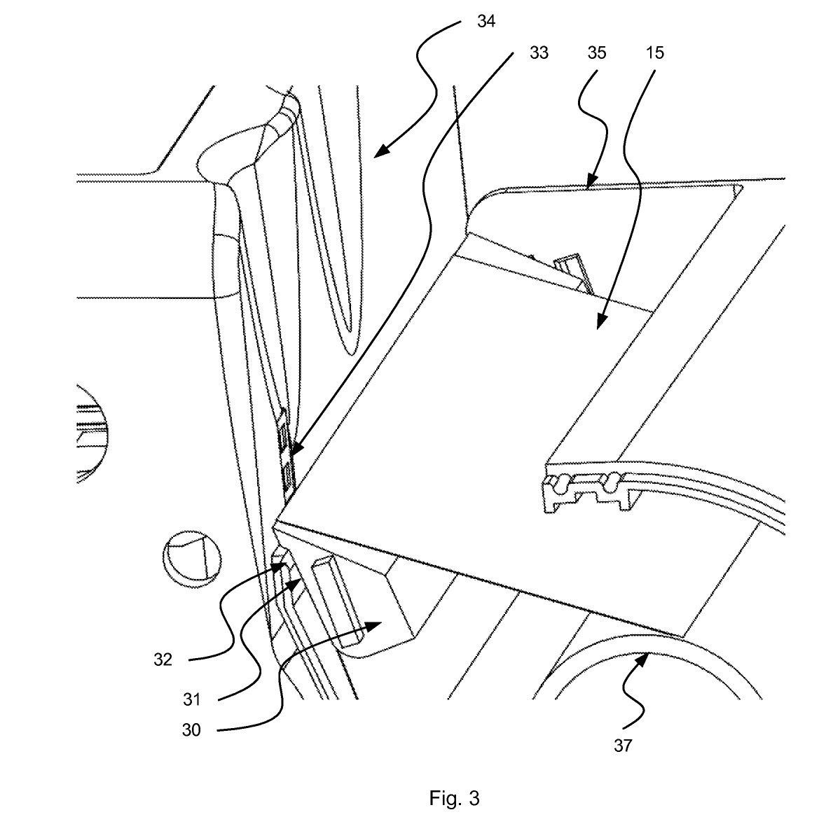

Referring now to the RFID encoder of FIG. 3, the present invention provides an apparatus and method to improve the dispensability of thin RFID inlay 10. In the preferred embodiment peel plate 30 is a component of cartridge 35 and is comprised of a sharp edge for peeling tags. Together with cartridge 35, a pinch region 31 is formed between peel plate 30 and the walls of cartridge 35 or encoder face 34 for peeling RFID transponders, especially thin inlays. Peel plate 30 or 43 is stiff enough to prevent flexure while under the tension of release liner web 15 that is created by the pulling torque of take-up roll 37. Many other shapes exist with similar such improved dispensability characteristics.

In this preferred embodiment, the pinching of the release liner in pinch region 31 between peel plate 30 and cartridge housing lip 32 of cartridge 35 or encoder face 34 results in inlays peeling from the distal end of peel plate 30 or 43 reliably over a range of operating temperatures. It is well known to those skilled in the art that the plastic materials from which RFID inlays are made, such as PET, become softer at elevated temperatures, and stiffer at reduced temperatures. It is also well known that as an inlay becomes softer it is more difficult to separate it from the release liner using the shape memory properties of an inlay. It is also well known that many adhesives flow and bond more tightly to release liner at elevated temperatures, even after being cooled.

As the release liner advances, the thin inlays peel away, separating from the release liner. With close proximity to encoder face 34, inlay 10 is forced into a position that is coplanar with face 34. Certain embodiments use optical sensor 33 to detect the arrival or presence of an RFID tag or inlay 10 that is one of a plurality of transponders that are adhered to advancing release liner 15. Optical sensor 33 is preferably embedded and recessed such that when inlay 10 is forced into a coplanar orientation with face 34, inlay 10 is at or near the focal point of optical sensor 33 and light is reflected squarely back into it. This method of sensing shiny inlays with significant amounts of specular reflection preferably results in high amplitude signals that provide clear and unambiguous indications of the presence of peeled inlay 10. This preferred apparatus for peeling and sensing RFID tags will also work with diffuse reflective facestock characteristics, although diffuse reflective characteristics of the tag or inlay is not a necessary requirement. This is a significant difference from all prior art which all use some form of optical reflection from a diffuse surface to detect the presence and location of RFID transponders. Diffuse characteristics of the transponder are an important, if not practically necessary property for human-readable or machine readable printing. This is because light is scattered over a broader angular area, with a sufficient amount of light reflected for human readability or reliable optical tag detection.

Since RFID inlays are constructed from plastic materials and metals having a high degree of specular reflection, it is necessary to have a transponder detection means that is not affected by specular reflection. The coplanar optical alignment structure described above is one preferred structure and set of elements for detecting a shiny inlay. In the next section, other non-optical elements and structures are disclosed herein as means for detecting the arrival of an inlay that is transported by an advancing release liner or conveyance web.

### Programming at the Peel Plate

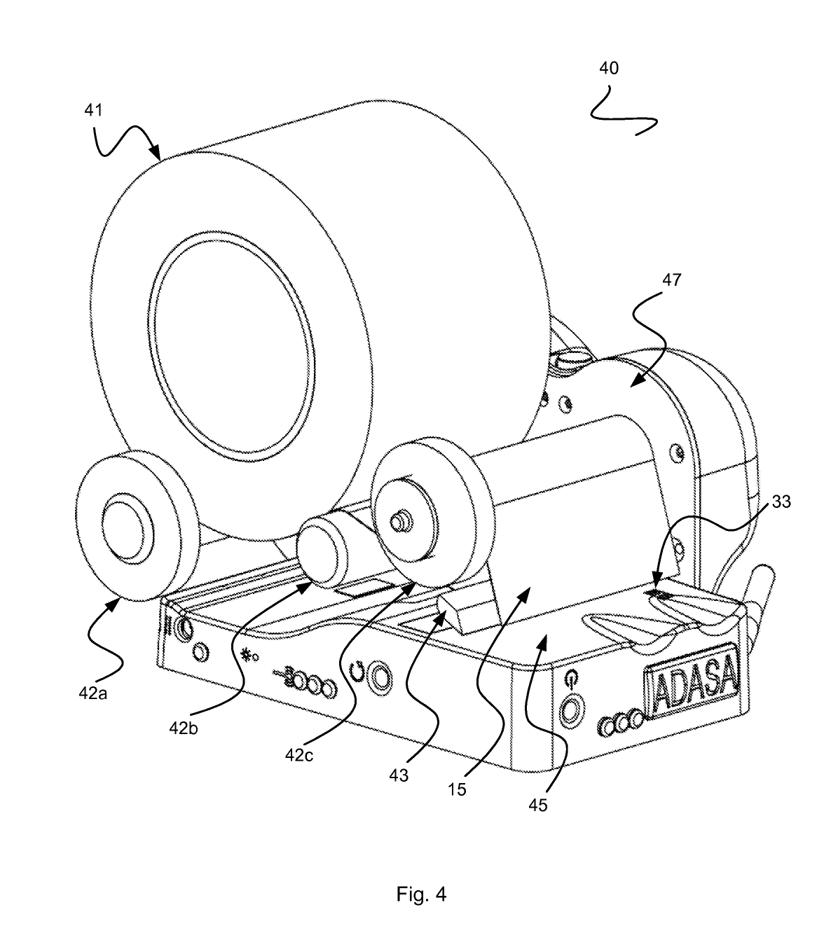

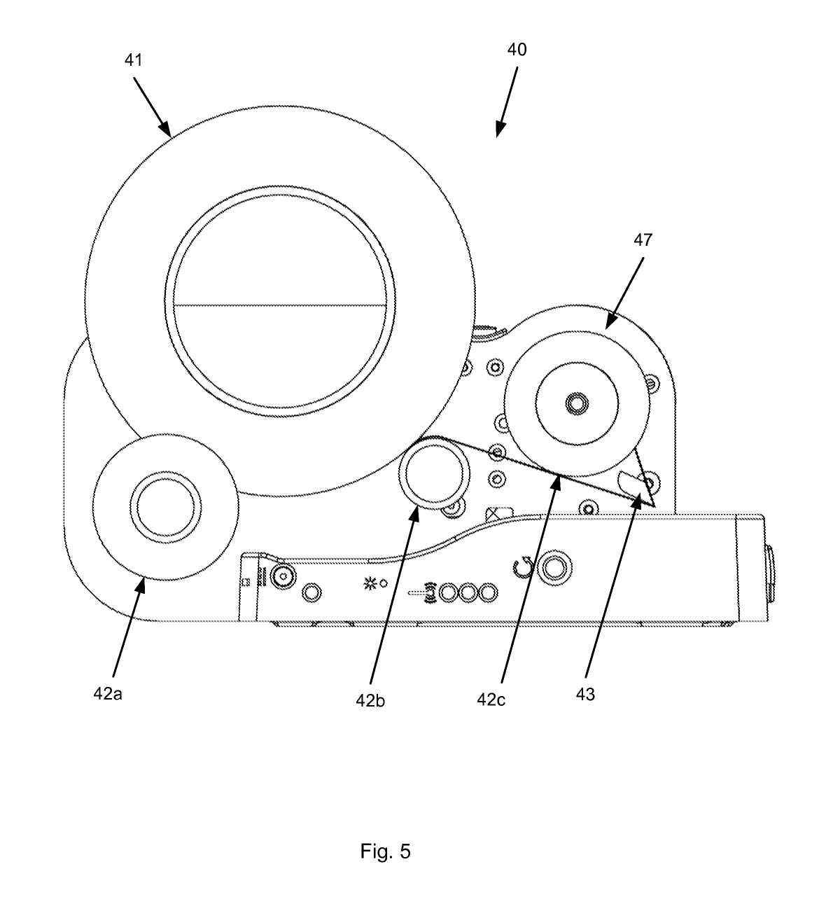

In certain preferred embodiments, RFID tags are assigned a unique SGTIN (Serialized Trade Item Number) when tags are separated one-by-one from the release liner at peel plate 30 or 43 of FIGS. 4 and 5. It is at that point that each tag physically breaks out of the space that is defined by the conveyance web or the release liner 15. It is at that point that a tag or inlay 10 receives a unique identity and becomes ready for physical transfer to the object to which it has been assigned. Up until the moment that the movement begins, and a particular RFID tag or inlay 10 is physically committed to an object, the tag's unique identity can be altered by RFID tag encoder 40. An encoded and ready tag can be halted in its commissioning process and reprogrammed with a different SGTIN that represents a different SKU (Stock Keeping Unit). Therefore an inlay means having been programmed with a first identity, can be intentionally reprogrammed with a second different identity. This facilitates a tagging process whereby the number of consecutive tags of an SKU is not previously known or pre-counted. The operator can complete the tagging of several instances of the same SKU, then change on-the-fly to a different SKU without wasting any tags or inlays.

RFID tags are provided in source sheets or rolls. In certain preferred embodiments rolls are encased by cartridges that protect the tags.

In a preferred embodiment, source rolls of inlay 10 on release liner 15 are wound onto a rigid paper core that typically has an inner diameter of three inches and less than a four inch outer diameter. The resulting source roll 41 is in the present embodiment, set onto a pair of rollers. Freewheeling roller 42a and drag brake roller 42b cradle source roll 41. Drag brake roller 42b has a resistive torque, which can be adjusted to increase or decrease the back torque. In doing so, the tension in conveyance web 44 can be adjusted to ensure successful peeling of tags and inlays.

In preferred embodiments roller 42a and take-up roller 42c have flanges that act as web guides to prevent conveyance web 44 from wandering. Face plate 47 provides a hard stop on the opposite side of conveyance web 44 to prevent over travel in that direction. Peel plate 43 preferably peels RFID tags and inlays 10 such that they are detected by sensor 46. Sensor 46 is preferably an optical sensor that detects reflected infrared light, but may be any of several other types of sensors that are well known to those skilled in the art, including a near field coupler that is under the control of an RFID interrogator that is preferably positioned under encoder face 45 to send and receive radio signals for reading, programming, and securing RFID tags and inlays. When using a near field coupler in this manner, the presence of inlays is sensed by the RFID interrogator's ability to select, read, or write to inlay 10. A near field coupler preferably communicative with a transponder only after it has physically begun to separate from release liner 15 and preferably press against encoder face 34.

The advantage of this type of sensor is to avoid the dependence upon any particular optical properties of inlay 10. A preferred embodiment of RFID inlay encoder 40 detects the presence of inlay 10 which is advancing on release liner 15, using only the results of a series of attempts by its RFID interrogator to select, read, or write to the inlay only when inlay 10 is located at the sharp distal end of peel plate 30 or 43.

When external connection is necessary, wired or wireless communication with an external host or numbering authority is established. Wireless communication is preferably a Wi-Fi or Bluetooth connection. A wireless node of a Bluetooth personal area network is used according one embodiment of the present invention. BISMS02 is a preferred Bluetooth model from EZURiO Ltd., a subsidiary of Laird Technologies, Inc. of Chesterfield. Other wireless interfaces may alternatively be used to achieve Serial Port Profile and other types of connectivity with a host computer, a mobile phone, or optical reader.

Other preferred embodiments of encoder 40 replace wireless communication means with a cable such as RS-232 or USB.

The operator can cause encoder 40 to commission a transponder by scanning certain printed bar code symbols received through an optical reader or portable data terminal which is connected to encoder 40 through a wireless communication means. Or alternatively an internal optical reader is used to scan printed bar code symbols. In either case data from an optical reader is delivered to a processing means. Certain preferred embodiments use optical scanners with self-contained symbol decoding capabilities to deliver decoded symbol information to the processing means. Certain other embodiments rely on the processing means to conduct some or all decoding operations to derive information from scanned symbols.

The information received from the optical reader is used by encoder 40 to receive for example a complete SGTIN data specification or a GTIN specification that is used to formulate an SGTIN to encode into RFID inlay 10 while it is at peel plate 43. In preferred embodiments an encoded inlay 10 can also be reprogrammed using a different GTIN or SGTIN number if it is still at peel plate 43.

A preferred embodiment of an optical reader is a Motorola model LS-2208 or a Bluetooth model CHS-7M or CHS-7P manufactured by Socket Communications of Newark, Calif.

Processing scanned commands involves a processing step to determine that a bar code should be interpreted as a command or configuration instructions rather than as bar code that identifies an object that is to be tagged. Commands are used to alter the flow and operation of the encoder. In a preferred embodiment abbreviated XML-like commands are used for this purpose.

The commissioned inlay 10 is associated and applied to the target object by a human operator or a machine transfer.

While the invention has been particularly shown and described with reference to certain embodiments, it will be understood by those skilled in the art that various changes in form and detail may be made without departing from the spirit and scope of the invention.

We claim:

1. RFID consumer notification text and symbols that are intrinsic to the antenna layer of an RFID transponder.

2. RFID consumer notification text and symbols of claim 1 that are comprised of the same material of that of the antenna.

3. RFID consumer notification text and symbols of claim 1 that are radiating elements of the antenna.

4. An RFID inlay encoder that encodes RFID inlays, comprising:
an RFID interrogator means for selecting, reading, or writing to RFID inlays;
an advancing release liner means;
a plurality of thin RFID inlay means that are adhered to the release liner means;
a peel plate and a pinch region means for peeling inlays from the advancing release liner means.

5. The RFID interrogator means of claim 4 that detects the presence of an inlay using only the results of successful attempts to select, read, or write to the inlay only when the inlay has physically advanced to a location at the sharp distal end of the peel plate.

6. The inlay means of claim 4 having been programmed with a first identity, intentionally reprogrammed with a second different identity.

7. The peel plate means of claim 4 that forms a pinch region means with an adjacent cartridge wall or encoder face for reliable separation of tags and inlays from a release liner over a range of operating temperatures.

8. An RFID tag encoder comprised of a freewheeling roller and a drag brake roller to cradle a source roll of RFID tags.

9. The drag brake roller of claim 8 having an adjustable drag torque to vary web tension.
